(19) United States
(12) Patent Application Publication
(10) Pub. No.: US 2018/0129219 A1
(43) Pub. Date: May 10, 2018

(54) AUTONOMOUS VEHICLE MOVING SYSTEM, DEVICE AND METHOD

(71) Applicant: Aatonomy, Inc., San Francisco, CA (US)

(72) Inventors: Ronald Wilson Pulling, San Francisco, CA (US); Yang Hu, San Francisco, CA (US)

(21) Appl. No.: 15/808,880

(22) Filed: Nov. 9, 2017

Related U.S. Application Data
(60) Provisional application No. 62/419,838, filed on Nov. 9, 2016.

(51) Int. Cl. G05D 1/02

(52) U.S. Cl. CPC G05D 1/0246; G05D 1/0202

(57) ABSTRACT

A system, device, and method for moving an autonomous vehicle (AV) are disclosed. The AV moving system could include the AV configured with one or more image capturing devices, and a processing unit (PU). The PU may be configured to receive input data representative of one or more selections of one or more predefined operational modes; receive image data representative of an image of one or more objects located in a scene outside of the AV; receive input data representative of a selection of an object; track the image of the selected object as a function of a visual tracking algorithm; generate output data as a function of the selection(s) of the predefined operational modes and the tracking of the image of the selected object; and send the output data to the AV via the datalink.

### CROSS REFERENCE TO RELATED APPLICATIONS

This application claims priority to U.S. provisional applications No. 62/419,818 entitled “DEVICES, SYSTEMS, AND METHODS FOR A CINEMATIC FOLLOWING USING VISUAL TRACKING SYSTEMS” filed Nov. 9, 2016 and No. 62/419,838 entitled “MODULAR INTELLIGENCE PLATFORM FOR AUTONOMOUS ROBOTIC APPLICATIONS” filed Nov. 9, 2016, which are herein incorporated by reference in their entirety.

### BACKGROUND

Photography and videography enthusiasts have employed the use of newer and advanced camera and video equipment as technology has progressed. The use of robots and drones has become increasingly popular to take aerial shots of objects of interest. Drones and robots have features implemented to track objects such as people and follow the objects around while recording video or taking photos. For example, some drones include a feature commonly referred to as “follow me,” where the drone follows a person from behind to take a third person perspective photo or video. Other drones employ a feature where the drone follows the object of interest, which generally carries a global positioning system (GPS) tracker device.

### SUMMARY

Embodiments of the inventive concepts disclosed herein are directed to a system, device, and method for moving an autonomous vehicle (AV). An AV moving system could be employed to provide a technique for moving the AV without the need of a separate tracking device.

In one aspect, embodiments of the inventive concepts disclosed herein are directed to a system for moving an AV. The system could include the AV configured with one or more image capturing devices, and a processing unit (PU). In some embodiments, the PU could be located on the AV.

In a further aspect, embodiments of the inventive concepts disclosed herein are directed to a device for moving the AV. The device could include the PU configured to perform the method in the paragraph that follows.

In a further aspect, embodiments of the inventive concepts disclosed herein are directed to a method for moving the AV. When properly configured, the PU may receive input data representative of one or more selections of one or more predefined operational modes; receive image data representative of an image of one or more objects located in a scene outside of the AV from the AV via a datalink; receive input data representative of a selection of one object where there is more than one object presented in the image; track the image of the selected object as a function of a visual tracking algorithm; generate output data as a function of the selection(s) of the predefined operational modes and the tracking of the image of the selected object; and send the output data to the AV via the datalink. When received, a control system configured to control movement of the AV may control a plurality of control devices responsive to the output data to move the AV commensurate to the output data. In some embodiments, the PU may receive GPS data representative of an object located in a scene outside of the AV. In some embodiments, the PU may receive beacon-based relative distance data representative of an object located in a scene outside of the AV. In some embodiments, the PU may receive inertial measurement data representative of an object located in a scene outside of the AV.

### BRIEF DESCRIPTION OF THE DRAWINGS

For a fuller understanding of the inventive embodiments, reference is made to the following description taken in connection with the accompanying drawings in which:

FIG. 1A depicts a person remotely controlling an AV, in accordance with various embodiments;

FIG. 1B depicts a functional block diagram of the AV moving system, in accordance with various embodiments;

FIGS. 2A-2F depict longitudinal movements of an AV with respect to an object, in accordance with various embodiments;

FIGS. 3A-3F depict rotational movements of an AV with respect to an object, in accordance with various embodiments;

FIGS. 4A-4F depict lateral movements of an AV with respect to an object, in accordance with various embodiments;

FIGS. 5A-5B depict simultaneous longitudinal and rotational movements of an AV with respect to a mobile object that is employable in “Following from Behind” and “Backwards Following” operational modes, in accordance with various embodiments;

FIGS. 6A-6B depict simultaneous longitudinal and lateral movements of an AV with respect to a mobile object that is employable in a “Locked Perspective Following” operational mode, in accordance with various embodiments;

FIGS. 7A-7F depict orbital movement of an AV with respect to an object, in accordance with various embodiments;

FIGS. 8A-8F depict simultaneous longitudinal, rotational, and lateral movements of an AV with respect to an object, in accordance with various embodiments;

FIGS. 9A-9B depict simultaneous longitudinal, rotational, and lateral movements of an AV with respect to a mobile, rotatable object that is employable in a “Rotational Following” operational mode, in accordance with various embodiments;

FIG. 10 depicts frames of a cinematic following employing various operational modes, in accordance with various embodiments; and

FIG. 11 depicts an exemplary embodiment of a flowchart disclosing a method for moving an AV, in accordance with various embodiments.

### DETAILED DESCRIPTION

In the following description, several specific details are presented to provide a thorough understanding of embodiments of the inventive concepts disclosed herein. One skilled in the relevant art will recognize, however, that embodiments of the inventive concepts disclosed herein can be practiced without one or more of the specific details, or in combination with other components, etc. In other instances, well-known implementations or operations are not shown or described in detail to avoid obscuring aspects of various embodiments of the inventive concepts disclosed herein.

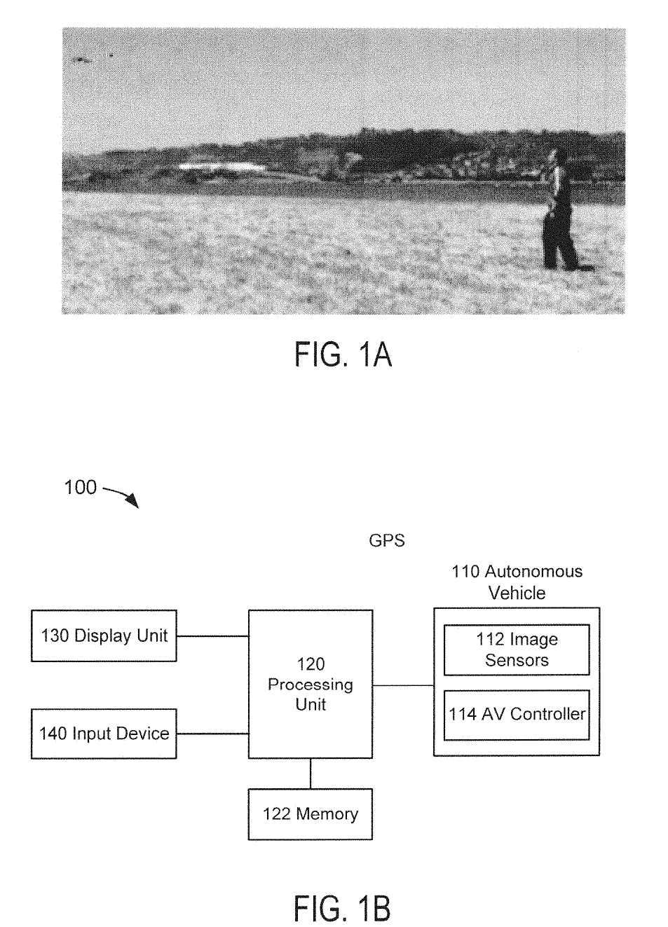

Referring now to FIGS. 1A-1B, an embodiment of an AV moving 100 suitable for implementation of the inventive concepts described herein includes an autonomous vehicle (AV) 110, a processing unit (PU) 120, a display unit (DU) 130, and an input device (ID) 140.

AV 110 could include any robotic device, vehicle, and/or multiple devices (e.g., swarms of vehicles) configurable to follow an object of interest that may include an image sensor(s) 112 and AV control system 114. AV 110 could include any vehicle which is capable of flying through the air, atmosphere, and/or space including, but not limited to, lighter than air vehicles and heavier than air vehicles, wherein the latter may include remotely-controlled quadcopters, fixed-wing, and rotary-wing vehicles. Additionally, AV 110 could include any robotic system including legged robots and/or vehicles capable of traversing the surface of the Earth, and/or any watercraft capable of unmanned/autonomous operation on or beneath water.

Image sensor 112 could include one or more image sensors configured to capture image data representative of an image of one or more real-time images presented on DU 130. In some embodiments, the image sensor 112 could include a camera sensor(s) designed to work within the visible electromagnetic spectrum bandwidth and used to detect visible light detectable by the human eye. In some embodiments, the image sensor 112 could include an infrared (IR) sensor(s) designed to work within the IR electromagnetic spectrum bandwidth. It should be noted that data described herein such as the image data and output data could include any analog or digital signal, either discrete or continuous, which could contain information or be indicative of information. As embodied herein, signals are synonymous with data.

AV control system 114 could include any system on AV 110 that is configured to control a plurality of control devices that may be used, for example, to power or steer AV 110. A non-exhaustive list of such control devices include engines, motors, propellers, ailerons, rudders, flaps, slats, and stabilizers. In some embodiments, AV control system 114 could include a controller configured to receive output data generated by PU 120 that is representative of command(s) commensurate to controlling movement of the AV as discussed below. In some embodiments, the controller could include any electronic data processing unit as disclosed below, where the controller could be configured with software or computer instruction code known to those skilled in the art.

PU 120 could include any electronic data processing unit which executes software or computer instruction code that could be stored, permanently or temporarily, in a digital memory storage device or a non-transitory computer-readable media (generally, memory 122) including, but not limited to, random access memory (RAM), read-only memory (ROM), compact disc (CD), hard disk drive, diskette, solid-state memory, Personal Computer Memory Card International Association card (PCMCIA card), secure digital cards, and compact flash cards. PU 120 may be driven by the execution of software or computer instruction code containing algorithms developed for the specific functions embodied herein. PU 120 may be an application-specific integrated circuit (ASIC) customized for the embodiments disclosed herein. Common examples of electronic data processing units are microprocessors, Digital Signal Processors (DSPs), Programmable Logic Devices (PLDs), Programmable Gate Arrays (PGAs), and signal generators; however, for the embodiments herein, the term “processor” is not limited to such processing units and its meaning is not intended to be construed narrowly. For instance, PU 120 could also include more than one electronic data processing unit. In some embodiments, PU 120 could be a processor(s) used by or in conjunction with any other system employed herein including, but not limited to, AV 110, DU 130, and ID 140.

In some embodiments, the terms “programmed” and “configured” are synonymous. PU 120 may be electronically coupled to systems and/or sources to facilitate the receipt of input data. In some embodiments, operatively coupled may be considered as interchangeable with electronically coupled. It is not necessary that a direct connection be made; instead, such receipt of input data and the providing of output data could be provided through a bus, through a wireless network, or as a signal received and/or transmitted by PU 120 via a physical or a virtual computer port. PU 120 may be programmed or configured to execute the method discussed in detail below. In some embodiments, PU 120 may be programmed or configured to receive data from various systems and/or units including, but not limited to, AV 110 including image data received via a datalink, and ID 140. In some embodiments, PU 120 may be programmed or configured to provide output data to various systems and/or units including, but not limited to, AV 110 and DU 130.

ID 140 could include any tactile device (e.g., keyboard, control display unit, cursor control device (CCD), stylus, electronic grease pen, handheld device, touch screen device, notebook, tablet, or a user-wearable device). ID 140 could be integrated with DU 130 where configured to input (e.g., handheld device, touch screen device, notebook, tablet). In some embodiments, the ID 140 could include any voice input device that allows for a voice entry of data.

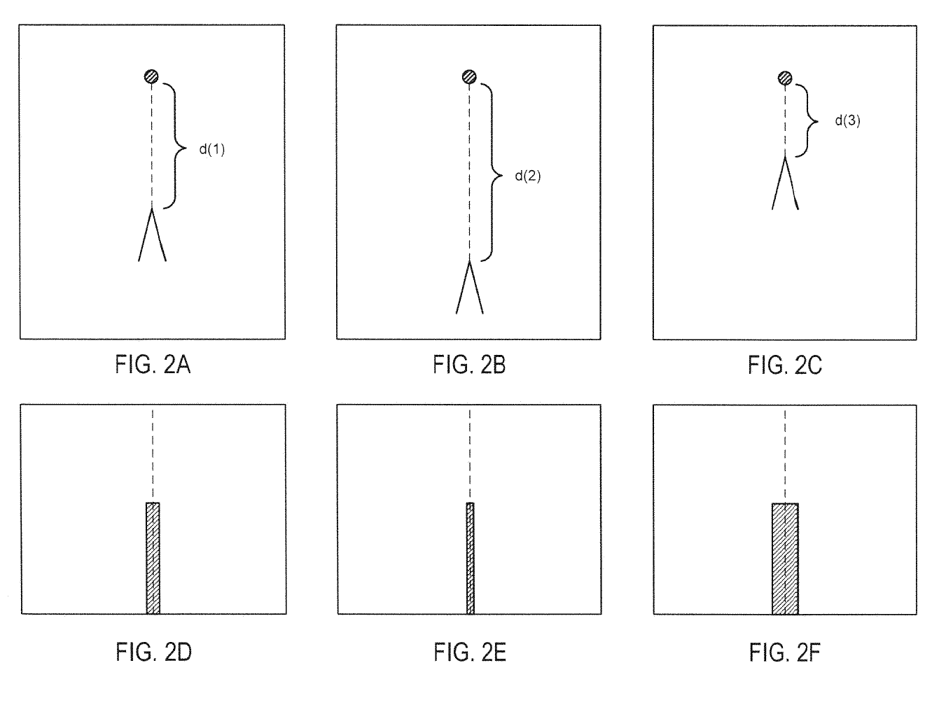

Some advantages and benefits of the inventive concepts disclosed herein are shown in FIGS. 2A through 11, illustrating movements along or about axes and various operational modes that may be employed by the AV moving system 100. Longitudinal movement may be defined as forwards and backwards movements relative to an object such as, but not limited to, persons, animals, vehicles, or any other stationary or mobile objects located in a scene outside of the AV along a longitudinal axis extending from the AV to the object; rotational movement may be defined as clockwise and counterclockwise rotation about a vertical axis of the AV; lateral movement may be defined as left and right (i.e., side) movements relative to the object along a lateral axis that is perpendicular to the longitudinal axis; and vertical movement may be defined as up and down movements relative to the object and along the vertical axis.

Referring now to FIGS. 2A through 2F, longitudinal movement of an AV with respect to an object is illustrated in accordance with various embodiments. FIGS. 2A through 2C provide overhead views, and FIGS. 2D through 2F provide respective side views from the point of view of the AV.

As shown in FIG. 2A, the AV (illustrated as a chevron) is located at a point directly facing and longitudinally aligned with the object (illustrated as a circle) at a relative distance d(1). As shown in FIG. 2D, a displayable image of the scene located outside of the AV that includes an image of the object (illustrated as a cross section of a cylinder) has been produced from AV image sensor(s). As shown in FIGS. 2B and 2E, the AV 1 has moved longitudinally backward as indicated by a greater relative distance d(2) and a narrower width of the object's image in the side view. Similarly, as shown in FIGS. 2C and 2F, the AV has moved longitudinally forward from its position of FIG. 2A as indicated by a lesser relative distance d(3) and a wider width of the object's image in the side view.

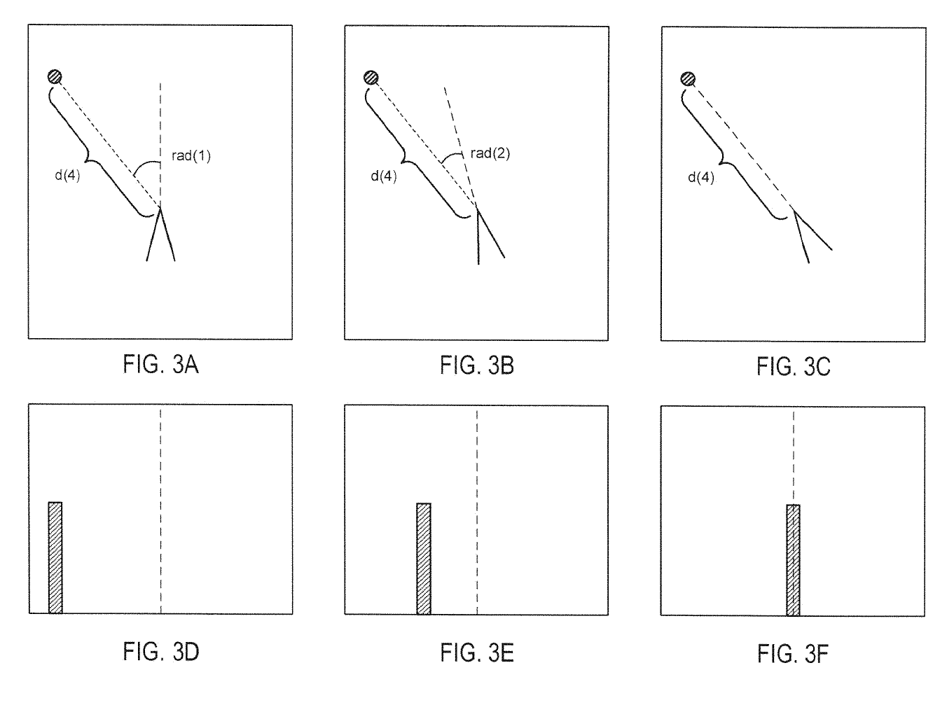

Referring now to FIGS. 3A through 3F, rotational movement of the AV with respect to an object is illustrated in accordance with various embodiments. FIGS. 3A through 3C provide overhead views, and FIGS. 3D through 3F provide side views from a point of view of AV.

As shown in FIG. 3A, the AV is located at a point that is a relative distance d(4) from the object and facing away from it at a relative angle rad(1). As shown in FIG. 3D, a displayable image of the scene located outside of the AV has been produced from AV image sensor(s). As shown in FIGS. 3B and 3E, the AV has rotated towards the object as indicated by a lesser relative angle rad(2) and the object's image has shifted to the right while the relative distance d(4) and the width of the object's image stay the same. Similarly, as shown in FIGS. 3C and 3F, the AV has rotated towards the object until the AV becomes longitudinally aligned with and directly facing the object, which is indicated by a further shift to the right of the object's image until the object's image is centered within the frame.

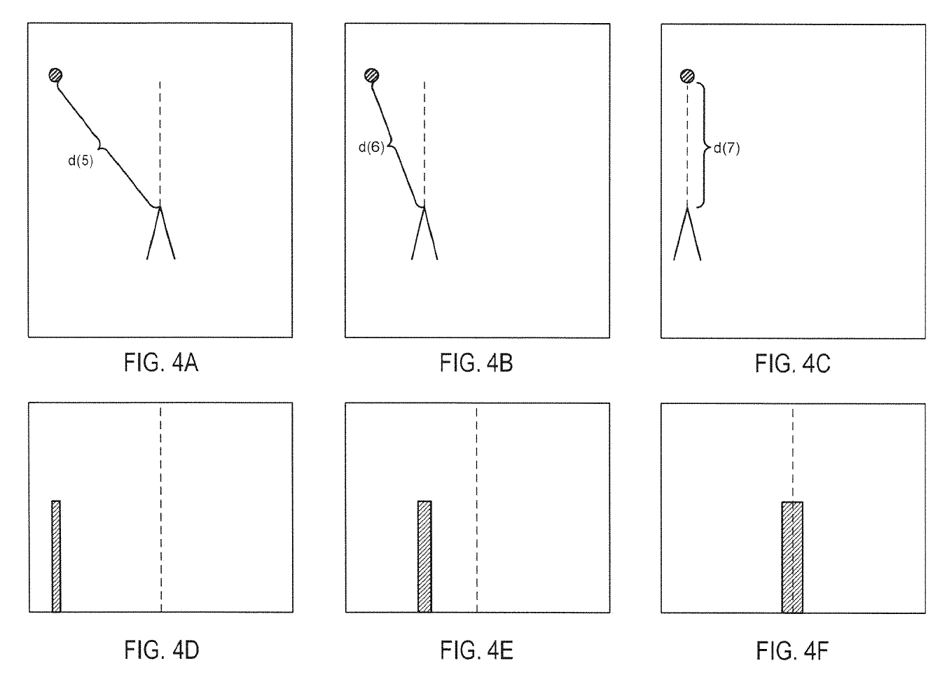

Referring now to FIGS. 4A through 4F, lateral movement of the AV with respect to an object is illustrated in accordance with various embodiments. FIGS. 4A through 4C provide overhead views, and FIGS. 4D through 4F provide side views from a point of view of AV.

As shown in FIG. 4A, the AV is located at a point that is a relative distance d(5) from the object. As shown in FIG. 4D, a displayable image of the scene located outside of the AV has been produced from AV image sensor(s). As shown in FIGS. 4B and 4E, the AV has moved laterally as indicated by the lesser relative distance d(6), a wider width of the object's image in the side view, and a shift to the right of the object's image. Similarly, as shown in FIGS. 4C and 4F, AV has moved laterally as indicated by even a lesser relative distance d(7), a wider width of the object's image, and a further shift to the right of the object's image until the object's image is centered within the frame. At this point, the AV is laterally aligned and directly faces the object, and is the closest to the object during the AV's lateral movement.

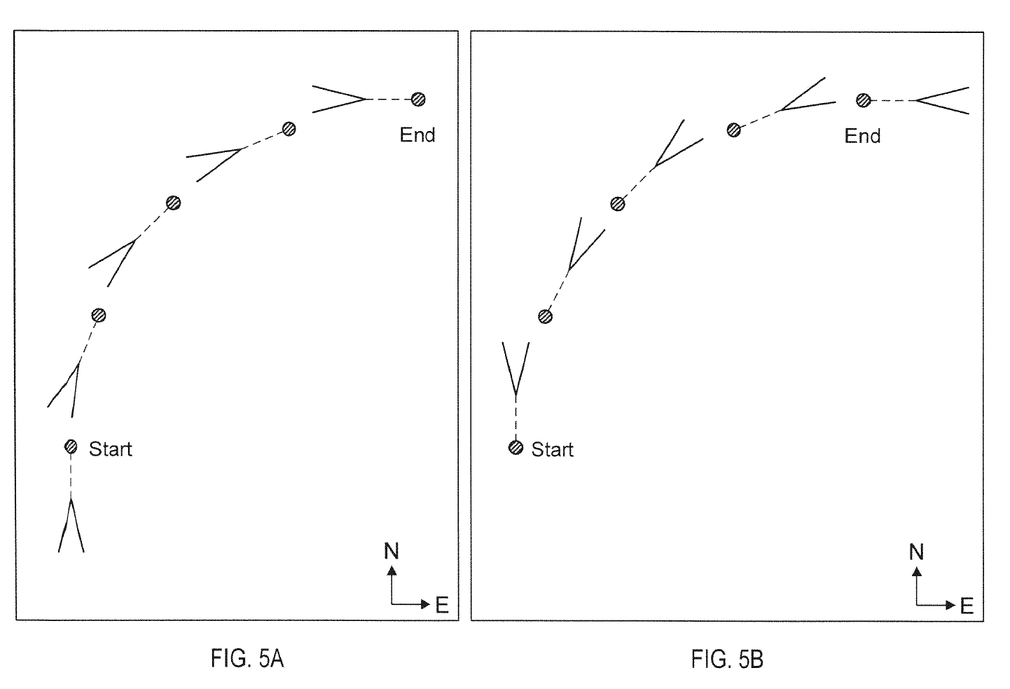

Referring now to FIGS. 5A and 5B, simultaneous longitudinal and rotational movements of the AV with respect to a mobile object are illustrated in accordance with various embodiments. The simultaneous movements shown in FIGS. 5A and 5B could be employed in “Following from Behind” and “Backwards Following” operational modes, respectively, to enable the AV to maintain a constant relative distance from a moving object.

As shown in FIG. 5A, the object starts moving in a northerly direction and ends its movement in an easterly direction. Prior to starting, it will be assumed that a constant relative distance is being maintained; that is, the AV is hovering at the relative distance from the object. When the movement starts, a visual tracking algorithm(s) known to those skilled in the art may recognize an increase in the relative distance movement. In response, the AV will have to move longitudinally forward to maintain the constant relative distance with the object until the object ends its movement. When the object begins to turn eastwardly, the algorithm(s) may recognize a change in direction. In response, the AV will have to rotate clockwise so that the AV continues to directly face the object to maintain longitudinal alignment until the object ends its movement, at which time the AV will have rotated ninety degrees to directly face the object in an easterly direction.

Similarly, as shown in FIG. 5B, the algorithm(s) may recognize a decrease in the relative distance movement. In response, the AV will have to move longitudinally backward to maintain the constant relative distance with the object until the object ends its movement. When the object begins to turn eastwardly, the algorithm(s) may recognize a change in direction. In response, the AV will have to rotate counter-clockwise about its vertical axis so that the AV continues to directly face the object to maintain longitudinal alignment until the object ends its movement at which time the AV will have rotated ninety degrees to directly face the object in a westerly direction.

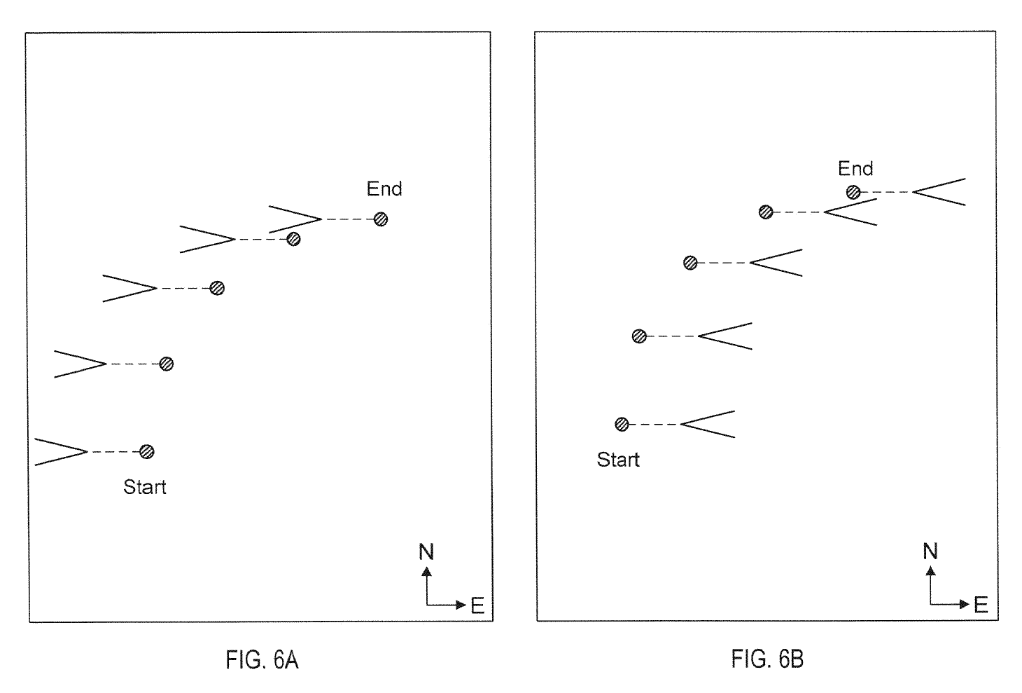

Referring now to FIGS. 6A and 6B, simultaneous longitudinal and lateral movements of the AV with respect to a mobile object are illustrated in accordance with various embodiments. The simultaneous movements shown in FIGS. 6A and 6B could be employed in a “Locked Perspective Following” operational mode to enable the AV to maintain a constant relative distance from a moving object.

As shown in FIG. 6A, the object starts moving in a northerly direction and ends its movement in an easterly direction. Prior to starting, it will be assumed that the AV is hovering to maintain a constant relative distance. When the movement starts, the algorithm(s) may recognize a change in direction. In response, the AV will have to move laterally to the left so that the AV continues to directly face the object to maintain lateral alignment until the object ends its movement. When the object begins to turn eastwardly, the algorithm(s) may recognize an increase in the relative distance movement. In response, the AV will have to move longitudinally forward to maintain the constant relative distance with the object until the object ends its movement.

Similarly, as shown in FIG. 6B, the algorithm(s) may recognize a change in direction. In response, the AV will have to move laterally to the right so that the AV continues to directly face the object to maintain lateral alignment until the object ends its movement. When the object begins to turn eastwardly, the algorithm(s) may recognize a decrease in the relative distance movement. In response, the AV will have to move longitudinally backward to maintain the constant relative distance with the object until the object ends its movement.

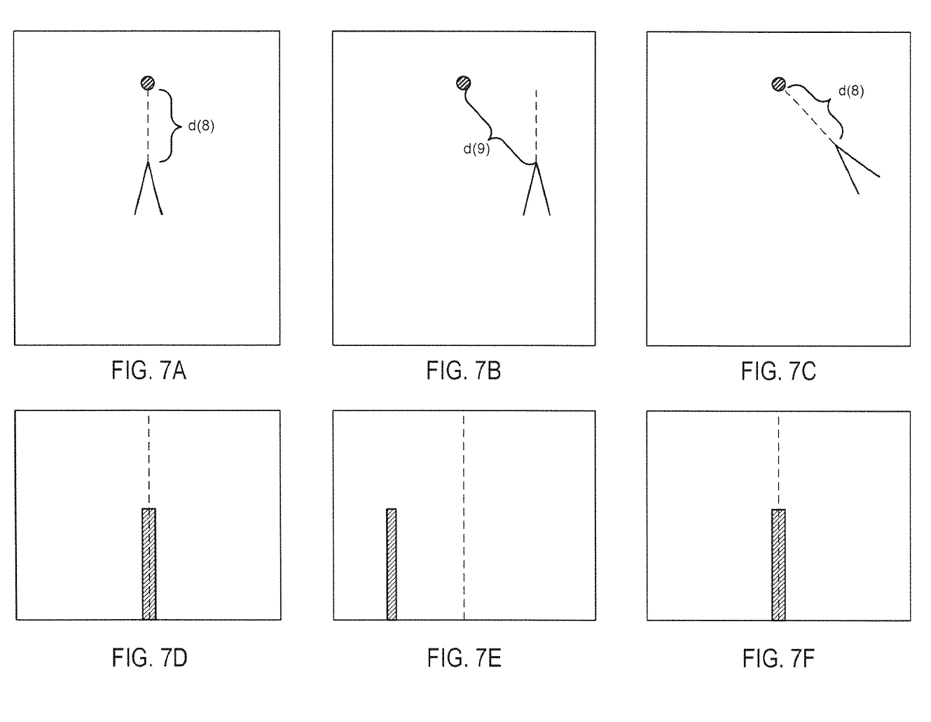

Referring now to FIGS. 7A through 7F, orbital movement of the AV with respect to an object is illustrated in accordance with various embodiments. FIGS. 7A through 7C provide overhead views, and FIGS. 7D through 7F provide side views from a point of view of AV.

As shown in FIG. 7A, the AV is located at a point that is a relative distance d(8) from the object. As shown in FIG. 7D, a displayable image of the scene located outside of the AV has been produced from AV image sensor(s). As shown in FIGS. 7B and 7E, the AV has moved laterally as indicated by a greater relative distance d(9), a narrower width of the object's image in the side view, and a shift to the left of the object's image. In response, the AV will have to move longitudinally forward to maintain the constant relative distance with the object and rotate counterclockwise to directly face the object. As a result, the AV may orbit the object at the constant relative distance d(8) while directly facing the object as shown in FIGS. 7C and 7F.

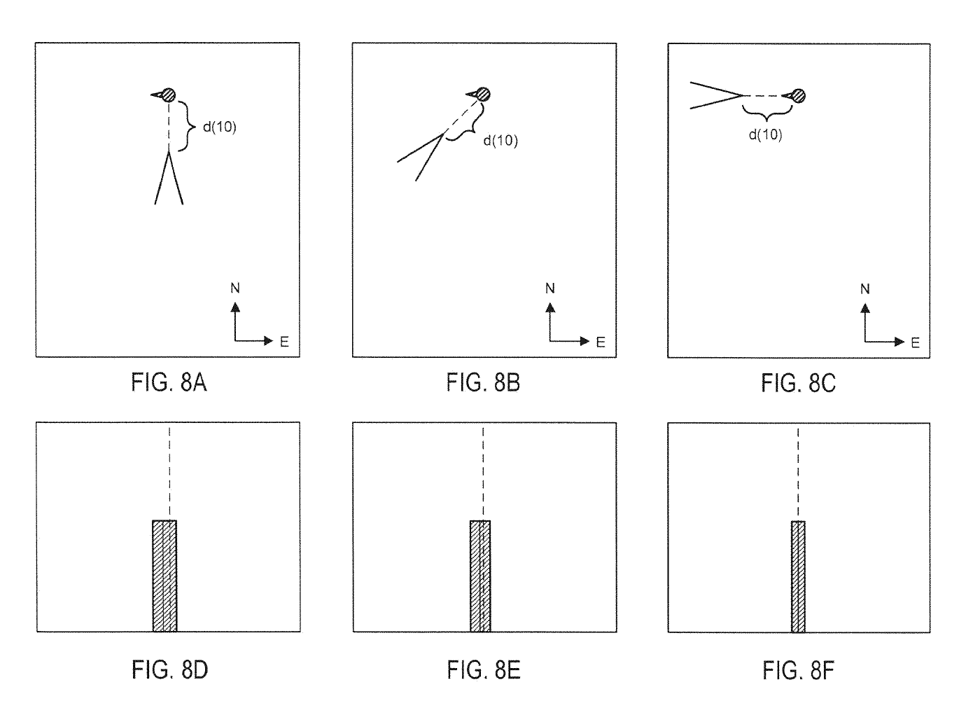

Referring now to FIGS. 8A through 8F, simultaneous lateral, longitudinal, and rotational movements of the AV with respect to an object are illustrated in accordance with various embodiments. These simultaneous movements shown could be employed in an “Orbital” operational mode to enable the AV to orbit the object at a constant relative distance while continuing to face the object. For the purpose of illustration, the orbit will be ninety degrees.

As shown in FIG. 8A, the AV is facing the object to the north while hovering at the relative constant distance d(10) from the object prior to the AV beginning a clockwise orbit. When the AV moves laterally to the left to start the orbit, a visual tracking algorithm(s) may recognize an increase in the relative distance movement and a change in direction. In response, the AV will have to rotate clockwise and move longitudinally forward so that the AV continues to maintain longitudinal alignment while maintaining the constant relative distance, respectively, as shown in FIGS. 8B and 8E. As the AV continues its orbit by continuing to move laterally, a visual tracking algorithm(s) may continue to recognize an increase in the relative distance movement and a change in direction. In response, the AV will have to continue its clockwise rotation and forward longitudinal movement so that the AV continues to maintain longitudinal alignment while continuing to maintain the constant relative distance, respectively, as shown in FIGS. 8C and 8F at which time the AV will have orbited ninety degrees.

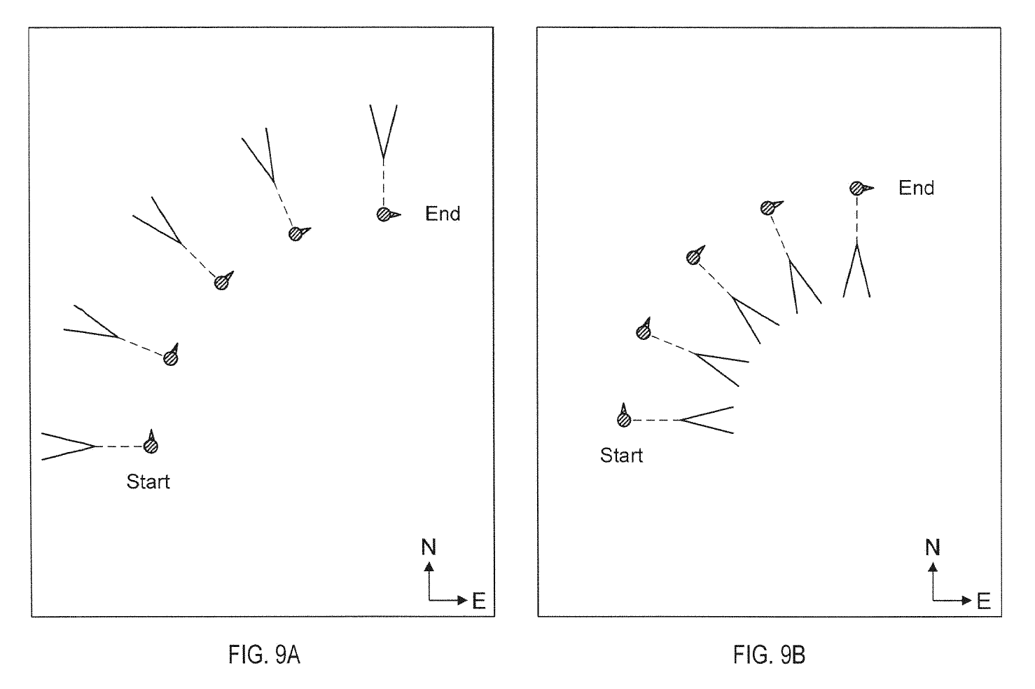

Referring now to FIGS. 9A and 9B, simultaneous lateral, longitudinal, and rotational movements of the AV with respect to a mobile, rotatable object are illustrated in accordance with various embodiments. The three simultaneous movements shown in FIGS. 9A and 9B could be employed in a “Rotational Following” operational mode to enable the AV to follow a moving, rotating object at a constant relative distance while continuing to face the same side of object (i.e., maintain a constant relative orientation).

As shown in FIG. 9A, the object starts moving in a northerly direction and ends its movement in an easterly direction. Prior to starting, it will be assumed that the AV is hovering to maintain a constant relative distance. When the movement starts, the algorithm(s) may recognize a change in direction and a change to the object's orientation. In response, the AV will have to move laterally to the left so that the AV continues to directly face the object to maintain lateral alignment until the object ends its movement. When the object begins to turn eastwardly and rotate clockwise, the algorithm(s) may recognize an increase in the relative distance movement and a change in relative orientation. In response, the AV will have to move longitudinally forward to maintain the constant relative distance and rotate clockwise to maintain the constant relative orientation until the object ends its movement.

Similarly, as shown in FIG. 9B, the algorithm(s) may recognize a change in direction. In response, the AV will have to move laterally to the right so that the AV continues to directly face the object to maintain lateral alignment until the object ends its movement. When the object begins to turn eastwardly and rotate clockwise, the algorithm(s) may recognize a decrease in the relative distance movement and a change in relative orientation. In response, the AV will have to move longitudinally backward to maintain the constant relative distance and rotate clockwise to maintain the constant relative orientation until the object ends its movement.

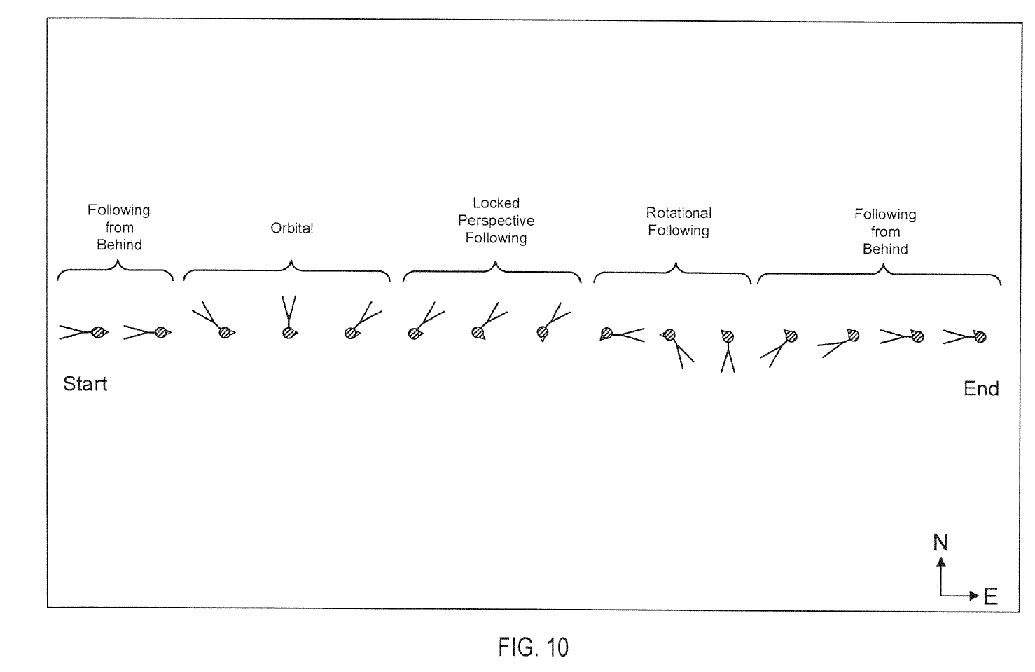

Referring now to FIG. 10, exemplary frames of a “Cinematic Following” operational mode sequentially employing a combination of operational modes are illustrated in accordance with various embodiments. As shown, there are sequential transitions between “Following from Behind”, “Orbital”, “Locked Perspective Following”, “Rotational Following”, and “Following from Behind” operational modes collectively referred to as “Cinematic Following” mode. The “Cinematic Following” mode is provided to illustrate how operational modes may be employed by sequentially performing each one to meet the needs of achieving cinema-quality shots and videos without the need to employ a separate tracking device. The ability to seamlessly and sequentially employ the operational modes may enable a user to create dramatic movements of AV 110 which could result in cinema-quality shots and videos.

As shown, the object moves in an easterly direction. Prior to starting, it will be assumed that a constant relative distance has been established and is being maintained; that is, the AV is hovering at the relative distance from the object. When the movement starts as the “Following from Behind” mode begins, a visual tracking algorithm(s) may recognize an increase in the relative distance movement. In response, the AV will have to move longitudinally forward to maintain the constant relative distance with the object until the sequence is ready to transition to the “Orbital” mode.

As discussed above, the “Orbital” mode may include simultaneous lateral, longitudinal, and rotational movements about and around their respective axes. To start the orbit, a lateral movement to the left may be smoothly applied as the object moves eastward until reaching the end of the mode. Simultaneously, the AV will have to rotate clockwise and move longitudinally forward as necessary so that the AV continues to maintain longitudinal alignment while maintaining the constant relative distance, respectively, during the lateral movement.

As discussed above, the “Locked Perspective Following” mode may include simultaneous longitudinal and lateral movements of the AV about their respective axes. As the movement transitions to the “Locked Perspective Following” mode, a lateral movement to the left may be continuously applied as the object moves eastward. Simultaneously, the AV will have to move longitudinally backward to maintain the constant relative distance with the object until reaching the end of the mode.

As discussed above, the “Rotational Following” mode may include simultaneous lateral, longitudinal, and rotational movements about and around their respective axes. As the movement transitions to the “Rotational Following” mode, a lateral movement to the left may be continuously applied as the object moves eastward. Simultaneously, the AV will have to move longitudinally forward to maintain the constant relative distance and rotate clockwise to maintain the constant relative orientation with the object until reaching the end of the mode.

As discussed above, the “Following from Behind” mode may include simultaneous longitudinal and rotational movements of the AV about and around their respective axes. As the movement transitions from the “Rotational Following” mode, the AV will have to continuously move longitudinally forward to maintain the constant relative distance with the object as it travels eastward. Simultaneously, the AV will have to rotate clockwise, as necessary, so that the AV continues to directly face the object to maintain longitudinal alignment until the object reaches the ends its movement.

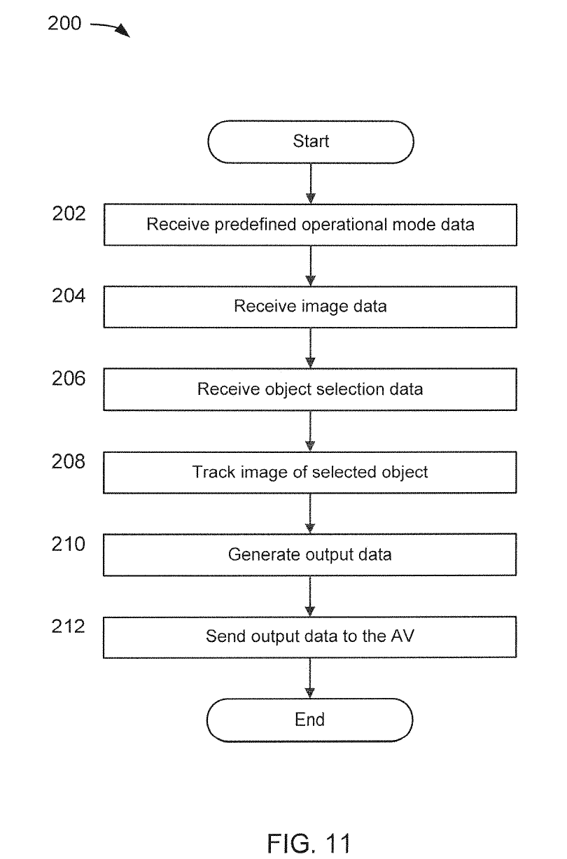

FIG. 11 depicts flowchart 200 disclosing an example of a method for moving an AV, where PU 120 may be programmed or configured with instructions corresponding to the modules embodied in flowchart 200. In some embodiments, PU 120 may be a processor or a combination of processors found in AV 110, DU 130, ID 140, or any other system suitable for performing the task. Also, PU 120 may be a processor of a module such as, but not limited to, a printed circuit card having one or more input interfaces to facilitate the two-way data communications of PU 120, i.e., the receiving and sending of data, the latter being synonymous with a providing and/or transmitting of data. As necessary for the accomplishment of the following modules embodied in flowchart 200, the acquiring of data is synonymous and/or interchangeable with the receiving and/or retrieving of data, and the providing of data is synonymous and/or interchangeable with the making available or supplying of data.

The method of flowchart 200 begins with module 202 with PU 120 receiving input data representative of one or more selections of predefined operational modes such as those discussed in detail above. In some embodiments, the selections could provide a sequence in which the predefined operational modes could be performed.

The method of flowchart 200 continues with module 204 with PU 120 receiving image data from AV 110 representative of an image that may be captured by one or more image sensors 112 mounted (i.e., installed) to the AV. In some embodiments, an image represented in the image data may be presented to a viewer by DU 130.

The method of flowchart 200 continues with module 206 with PU 120 receiving input data representative of a selection of one object shown appearing in the image. In some embodiments, the selection could be a default selection made by PU 120. In some embodiments, the selection could be made by an operator and/or end-user of the AV.

The method of flowchart 200 continues with module 208 with PU 120 tracking of the image of the selected object. In some embodiments, the tracking may be by one or more visual tracking algorithms known to those skilled in the art. In some embodiments, the tracking may monitor the image of the selected object for changes to the image commensurate to changes in the actual spatial relationship between the selected object and AV 110. In some embodiments, changes in the actual spatial relationship could include a change in the distance, the direction, and/or the orientation of the selected object relative to AV 110.

The method of flowchart 200 continues with module 210 with PU 120 generating output data as a function of one selection of the plurality of predefined operational modes and the tracking of the image of the selected object. In some embodiments, the output data could be representative of a command(s) commensurate to controlling movement of the AV about or along two or more axes. The axes may include the longitudinal axis along which AV 110 may move longitudinally, the lateral axis along which the AV 110 may move laterally, and the vertical axis about which the AV 110 may rotate.

In some embodiments, the output data could be representative of relative movement information of AV 110 with respect to the selected object along or about two or more axes. The relative movement information could include information of relative movement between AV 110 and the selected object along its longitudinal axis, along its lateral axis, and/or about its vertical axis.

The method of flowchart 200 continues with module 212 with PU 120 sending of the output data to AV 110 configured to receive and provide the output data to AV control system 114. In an embodiment in which the output data is representative of command(s), AV control system 112 could be configured to send individual commands to a plurality of control devices included in AV 110 that are employed to control the movement of AV 110 commensurate to the command(s) represented in the output data. In an embodiment in which the output data is representative of the relative movement information, AV control system 110 could be configured to control a plurality of control devices commensurate to the relative movement information represented in the output data. Then, the method of flowchart 200 ends.

It should be noted that the steps of the method described above may be embodied in computer-readable media stored in a non-transitory computer-readable medium as computer instruction code. The method may include one or more of the steps described herein, which one or more steps may be carried out in any desired order including being carried out simultaneously with one another. For example, two or more of the steps disclosed herein may be combined in a single step and/or one or more of the steps may be carried out as two or more sub-steps. Further, steps not expressly disclosed or inherently present herein may be interspersed with or added to the steps described herein, or may be substituted for one or more of the steps described herein as will be appreciated by a person of ordinary skill in the art having the benefit of the instant disclosure.

As used herein, the term “embodiment” means an embodiment that serves to illustrate by way of example but not limitation.

It will be appreciated to those skilled in the art that the preceding examples and embodiments are exemplary and not limiting to the broad scope of the inventive concepts disclosed herein. It is intended that all modifications, permutations, enhancements, equivalents, and improvements thereto that are apparent to those skilled in the art upon a reading of the specification and a study of the drawings are included within the broad scope of the inventive concepts disclosed herein. It is therefore intended that the following appended claims include all such modifications, permutations, enhancements, equivalents, and improvements falling within the broad scope of the inventive concepts disclosed herein.

What is claimed is:

1. A system for moving an autonomous vehicle (AV), comprising:
an AV configured with at least one image capturing device; and
a processing unit comprised of at least one processor coupled to a non-transitory processor-readable medium storing processor-executable code and configured to:
receive first input data representative of at least one selection of a plurality of predefined operational modes;
receive image data representative of an image of at least one object located in a scene outside of the AV from the AV via a datalink;
receive second input data representative of a selection of an object of the at least one object presented in the image;
track the image of the selected object as a function of a visual tracking algorithm;
generate output data as a function of the at least one selection of the plurality of predefined operational modes and the tracking of the image of the selected object; and
send the output data to the AV configured to receive the output data via a datalink, whereby
a control system configured to control movement of the AV controls a plurality of control devices responsive to the output data, thereby
moving the AV commensurate to the output data.

2. The system of claim 1, wherein at least one of the first input data and the second input data is received through a manual input device.

3. The system of claim 1, wherein at least one selection of a plurality of predefined operational modes corresponds to a sequence of predefined operational modes in which the AV moves.

4. The system of claim 1, wherein the visual tracking algorithm monitors a spatial relationship and changes thereto between the selected object and the AV.

5. The system of claim 4, wherein the changes of the spatial relationship includes at least one of a change of relative distance to the selected object, a change of relative direction of the selected object, and a change to the relative orientation of the selected object.

6. The system of claim 1, wherein the output data is representative of at least one command commensurate to controlling movement of the AV along or around at least two other axes.

7. The system of claim 1, wherein the output data is representative of relative movement information between the AV and the selected object along or around at least two other axes.

8. A device for moving an autonomous vehicle (AV), comprising:
a processing unit comprised of at least one processor coupled to a non-transitory processor-readable medium storing processor-executable code and configured to:
receive first input data representative of at least one selection of a plurality of predefined operational modes;
receive image data representative of an image of at least one object located in a scene outside of an AV via a datalink from the AV configured with at least one image capturing device;
receive second input data representative of a selection of an object of the at least one object presented in the image;
track the image of the selected object as a function of a visual tracking algorithm;
generate output data as a function of the at least one selection of the plurality of predefined operational modes and the tracking of the image of the selected object; and
send the output data to the AV configured to receive the output data via a datalink, whereby
a control system configured to control movement of the AV controls a plurality of control devices responsive to the output data, thereby
moving the AV commensurate to the output data.

9. The device of claim 8, wherein at least one of the first input data and the second input data is received through a manual input device.

10. The device of claim 8, wherein at least one selection of a plurality of predefined operational modes corresponds to a sequence of predefined operational modes in which the AV moves.

11. The device of claim 8, wherein the visual tracking algorithm monitors a spatial relationship and changes thereto between the selected object and the AV.

12. The device of claim 11, wherein the changes of the spatial relationship includes at least one of a change of relative distance to the selected object, a change of relative direction of the selected object, and a change to the relative orientation of the selected object.

13. The device of claim 8, wherein the output data is representative of at least one command commensurate to controlling movement of the AV along or around at least two axes.

14. The device of claim 8, wherein the output data is representative of relative movement information between the AV and the selected object along or around at least two axes.

15. A method for moving an autonomous vehicle (AV), comprising:
receiving, by a processing unit comprised of at least one processor coupled to a non-transitory processor-readable medium storing processor-executable code, first input data representative of at least one selection of a plurality of predefined operational modes;
receiving image data representative of an image of at least one object located in a scene outside of an AV via a datalink from the AV configured with at least one image capturing device;
receiving second input data representative of a selection of an object of the at least one object presented in the image;
tracking the image of the selected object as a function of a visual tracking algorithm;
generating output data as a function of the at least one selection of the plurality of predefined operational modes and the tracking of the image of the selected object; and
sending the output data to the AV configured to receive the output data via a datalink, whereby
a control system configured to control movement of the AV controls a plurality of control devices responsive to the output data, thereby
moving the AV commensurate to the output data.

16. The method of claim 15, wherein at least one selection of a plurality of predefined operational modes corresponds to a sequence of predefined operational modes in which the AV moves.

17. The method of claim 15, wherein the visual tracking algorithm monitors a spatial relationship and changes thereto between the selected object and the AV.

18. The method of claim 17, wherein the changes of the spatial relationship includes at least one of a change of relative distance to the selected object, a change of relative direction of the selected object, and a change to the relative orientation of the selected object.

19. The method of claim 15, wherein the output data is representative of at least one command commensurate to controlling movement of the AV along a longitudinal axis and along or around at least one other axis.

20. The method of claim 15, wherein the output data is representative of relative movement information between the AV and the selected object along a longitudinal axis and along or around at least one other axis.
